(19) United States
(12) Patent Application Publication
(10) Pub. No.: US 2022/0114635 A1
(43) Pub. Date: Apr. 14, 2022

(54) TRAVELING SHOPPER ORDERING AND FULFILLMENT SYSTEM

(71) Applicant: E-filliate, Inc., Rancho Cordova, CA (US)

(72) Inventor: Wesley K. Sumida, Fair Oaks, CA (US)

(21) Appl. No.: 17/499,074

(22) Filed: Oct. 12, 2021

Related U.S. Application Data
(60) Provisional application No. 63/090,390, filed on Oct. 12, 2020.

(51) Int. Cl. G06Q 30/06; G06Q 10/08; G06Q 50/30

(52) U.S. Cl. CPC G06Q 30/0619; G06Q 50/30; G06Q 10/083

(57) ABSTRACT

A plurality of inventory sets at various travel locations have their inventory contents communicated to a remote server computer. Travelers interact with the server computer, such as utilizing smart phones or other mobile computing devices through the Internet. Travelers can view inventory available at travel locations of interest, such as a traveler's destination, which could be a hotel or other temporary residence, or an intermediate destination for the traveler such as a rental car facility or a seat or cabin on an airplane, bus, train, vessel or other common carrier. Travelers can select item(s) for purchase (or rental) and make payment through interaction with the server computer. The server computer sends instructions to a delivery agent with access to the inventory at the travel location, and at least one ordered item is delivered to the traveler's destination.

### CROSS-REFERENCE TO RELATED APPLICATIONS

This application claims benefit under Title 35, United States Code §119(e) of U.S. Provisional Application No. 63/090,390 filed on Oct. 12, 2020.

### FIELD OF THE INVENTION

The following invention relates to computerized systems to facilitate ordering and delivering of items to a traveler. More particularly, this invention relates to ordering and delivery systems which facilitate ordering from an inventory at a travel location located at or near a traveler destination and delivery of ordered items to the traveler destination.

### BACKGROUND OF THE INVENTION

When one is traveling, it can be quite difficult to avoid forgetting some important item that will be needed on the trip. Some systems mitigate this problem by attempting to remind travelers with packing lists and other reminder systems, to not forget certain items. Yet, once travel has commenced, it is typically too late for such systems to be of assistance.

Goods delivery systems have evolved to be quite efficient, yet they are ill-suited to filling the needs of the traveling consumer. Delivery systems such as Amazon focus on delivery to existing addresses, rather than travel locations, and take at least a majority of a day to fill an order in most instances. A traveling consumer is a moving target. Speed and delivery to a logical spot (hotel room or rental car, etc.) are paramount.

Many hotels include gift shops, vending machines and other equipment to supply the myriad small items which are often forgotten by travelers. However, these known prior art shops and equipment for addressing this need have numerous drawbacks. Floor space is taken up by such equipment. Risk of theft is presented. Personnel or complex machinery are involved and add costs to efficiently operate. Furthermore, the headaches associated with maintaining inventory and otherwise managing a retail store business, become burdens which must be borne by the hotel staff.

Furthermore, known solutions to the problem of forgetting small items during traveling require that the traveler use up precious time to track down the forgotten items. Search time might involve travel down to the lobby, obtaining appropriate change for utilizing a vending machine, finding available hotel staff, walking to a convenience store and other wasted time and effort for the traveler. Accordingly, a need exists for a system which is more convenient, simpler and less time intensive for the traveler and which also avoids the drawbacks of known prior art systems from the standpoint of hotel operators.

### SUMMARY OF THE INVENTION

With this invention, a system is provided which allows for rapid and simple direct delivery of forgotten items to a door within a hotel of the traveler, in one embodiment, in a manner which minimizes burdens for the hotel staff as well in implementing the system. Both hotel staff and operators, as well as the traveling public, thus receive a tangible benefit.

The system of this invention includes three main parts, including a traveler smart phone (or other mobile (or non-mobile) computing device), an inventory location at or near each participating hotel (or other traveler destination) and a remote processor and associated memory housing a database and software for implementing the system of this invention. Other components of the system can include a wide area network such as the Internet, a receipt printer, a barcode scanner (typically a handheld wand type), hotel computer application software (or a similar app on a smart phone or tablet) and hotel personnel or other delivery personnel for delivering selected inventory items from an inventory location to the traveler's hotel room door or other drop off location (e.g. front desk of the hotel).

The processor and memory are typically part of a server computer at a location spaced from the inventory location and are programmed to run software and to maintain a database which facilitates the system of this invention. With regard to the database, in one form the database includes a list of participating hotels. For each participating hotel (or other travel location) a list of inventory items located at that hotel are included in the database. In one form of the invention, multiple hotels or other properties in close proximity might share a single inventory located near (i.e. within a delivery destination of) the hotel. The database would also typically include a price associated with each inventory item, and optionally other information including photos of items and other information generally known in inventory management and retail store software systems.

The processor and memory operate based on software contained within the memory or elsewhere, and potentially also contained within portions of the processor, at least temporarily. This software interacts with the inventory database, such as by adjusting the inventory database when items are added to or removed from inventory, and to factor in the results of periodic inventory checks. Furthermore, the software can facilitate adjustments to the database such as adjustments in price of the items within the inventory. The software also manages communication with travelers and communication with hotels and other delivery personnel.

The software can also be configured to manage e-commerce transactions, such as handling debit and credit cards for associated purchases (or coordinate with a separate e-commerce transaction system, e.g. Apple Pay by Apple, Inc. of Cupertino, Calif., Google Pay by Google, Inc. of Mountain View, Calif., PayPal by PayPal, Inc. of San Jose, Calif., etc. to potentially avoid setting up a new payment account). In one form of this invention, the database includes traveler information as well, such as traveler payment information and other unique information of the traveler which might be considered beneficial to provide an optimal experience for the traveler. Such information might include past transaction history information, traveler location information, traveler preferences information and other information about the traveler, which would typically be provided by the traveler or with the permission of the traveler when gathered from other sources.

Software associated with the system would also be contained within dedicated application software running on a smart phone (or tablet or other mobile (or non-mobile) computer device) of the individual traveler, generally referred to herein as an “app.” The app generally includes at least two fields which can be viewed and which interacts with the traveler . A first field lists hotels and other properties, and allows the traveler to select the hotel or other property where the traveler is located (or will be traveling to or through). In one embodiment, the software utilizes a location of the traveler to guess as to the hotel (or other traveler destination) where the traveler is located, or to create a short list of nearby hotels/properties from which the traveler can choose. This field can also allow for a room number to be entered for the traveler. In other embodiments, major hotel brands could be selected from menus or by clicking on hotel trademarks or other recognizable icons. Addresses could also conceivably be utilized. A search function could allow a traveler to enter information into a search box from which software would provide a list of at least partially matching hotels or other property locations from which the traveler can choose.

Once a traveler has selected a hotel or other property, which would generally match the location where the traveler is (or will be) located, the hotel or other property can optionally have information about the hotel automatically delivered for display on the app. This information might include advertising information and advertising services provided by the hotel, and which advertising services might be of interest to the traveler. Brand reinforcement displays can be uploaded to the app, so that the app takes on a customized appearance matching that of the hotel or other property where the traveler is located. In one embodiment, the app maintains a basic feel which matches the appearance of the app before a specific hotel or other property is identified, but which also provides strong confirmation to the traveler that the correct hotel has been selected. Other convenience information can also be displayed, such as weather information, traffic information, hotel maps, ordered item pickup location maps, local area maps, transportation schedules and other useful information.

In addition to such optional display of hotel specific information, an inventory screen also becomes active within the app which lists inventory which is available for purchase at the hotel or other property. This display typically prominently includes an input space where a traveler can search, such as by entering a name of a desired item, such as a forgotten travel item. In addition, items can be shown visually for browsing by a traveler. Typically this inventory list includes text information describing the inventory items available, typically also including a picture of the item and a price. Tabs can be provided to group items for sale (or rent) into categories.

When an item is selected, typically larger pictures of the item and more features of the item are displayed to confirm to the traveler that the correct item is being viewed. Navigation buttons allow for a traveler to readily go back to a previous screen if an undesired item is displayed.

Price information is also provided, as well as buttons to allow for confirming of purchase of a desired item. Most typically the app has had payment information preloaded therein, so that a traveler can very easily merely indicate a desire to have an item delivered, and the sale is consummated and the item is on its way toward delivery. As an alternative, a user can enter payment information separately. In one embodiment, a user has the option of charging the item to the room charges of the hotel visited by the traveler/customer, for final payment when leaving the hotel or other property, or to make other arrangements for payment through the hotel or other property.

After the item has been selected and payment made, most preferably the app converts into a third mode where it tracks the progress of the delivery. Simultaneously, and typically invisible to the traveler, instructions are sent to a computer associated with the hotel with instructions to deliver the specified inventory item to the specified room (or other drop-off location) of the traveler. This computer could be a desktop computer associated with the hotel, or could be a main database and communication system associate with the hotel, or could be a smart phone or other wireless electric device of a hotel employee or other delivery personnel.

In any event, particular instructions would be provided including the inventory item to deliver and a location for delivery. A promised time for delivery can also be provided, and appropriate warnings and updates can be provided if deadlines for delivery are approaching. In one embodiment, a centralized inventory location might serve multiple hotels, or the inventory could be a mobile van serving multiple hotels (or car rental lots or other locations). Delivery personnel would access this inventory and then travel to the hotel where the traveler is located, and then go on to the traveler/customer room for final delivery. As an alternative to delivery directly to the room of the traveler, selected items could be left at the front desk of the hotel or at some other delivery location. Such a delivery option might be selectable by a traveler who prefers not to provide a hotel room number for final delivery. A notification would occur when the item is ready for pickup.

Order information can also be printed out, such as at the front desk of the hotel, such as utilizing a Wi-Fi printer integrated into the system, which order information print out can be included with the order in one embodiment. This order information would this act like a receipt for a regular retail purchase transaction. As an alternative, or in addition, an email receipt or other electronic delivery of a receipt can occur through the system of this invention, or order information can be merely added to the folio of the traveler for settlement of charges upon traveler departure from the hotel.

With the resulting system, the traveler has the convenience of shopping for forgotten items or other items directly from a hotel room or some other location, and to have the forgotten item delivered directly to the room of the traveler, maximizing convenience and time savings. For the hotel, no vending space needs to be set aside for such vending services and no personnel are required to staff such vending locations on an ongoing basis. Hotel personnel are generally highly skilled at delivering services such as “room service” meals, laundry, etc. directly to rooms within the hotel. The system of this invention matches this skillset of hotel personnel to the further service of delivery of ordered items to the traveler, for maximum convenience and traveler satisfaction.

While a hotel is one traveler destination contemplated in the above described embodiment of this invention, other properties could be traveler destinations in other embodiments of this invention. As an example, instead of hotels and hotel travelers, the ancillary service of this invention could be combined with rental car services provided to rental car travelers. As one example, when a traveler has placed a reservation for a rental car, which often happens through an online platform, the rental car traveler could be queried as to whether the rental car traveler has other needs which might be provided along with the reservation of the rental car. A traveler could inquire positively to such a query and in the process launch a website or launch an app or invite the traveler to download an app. The website or app (which could be embedded into the rental car company website or app, or could be separate) could provide a listing of goods items which are available for purchase. These items could be general in nature, being items which travelers often need, or could be more focused on the needs of a rental car traveler. Examples of rental car specific goods could include navigation computers, cigarette lighter electronics adapter accessories, such as cell phone chargers and chargers for other electronics equipment, sunglasses, bottled water, snack foods, glucose pills, motion sickness pills, caffeine or other stimulant pills, maps, directories, specialty seat cushions, neck pillows, and any other of a variety of different car travel related items

These items available for purchase would be held in an inventory location at the rental car facility. When a traveler places an order, the items which have been ordered would be placed directly in the car which has been reserved by the traveler. In one embodiment, an insulated container could be utilized to house temperature sensitive items which have been requested by the traveler. As with the embodiment discussed above, rental car personnel would be designated to fulfill the order by receiving instructions to place the ordered items into the car for the traveler. The items are then ready when the traveler picks up the car. Payment for the items would typically be handled through the website when the order is placed.

Alternative ways to deliver the requested items to the traveler include holding the items at a check-in counter at a rental car facility for pick up by the traveler when checking in. If the traveler has pre-reserved a specific car, the items could be made available at a check-in counter without requiring that the traveler wait in line. As one example, a lockbox could contain the items and a code could be provided to the traveler for entry to open the lockbox and retrieve the requested items. As another option, after the traveler has picked up the rental car and is leaving a rental car facility, often a final control gate is passed through. The ordered items could be supplied to the traveler by the attendant at such a control gate.

In one embodiment, reservation details are provided related to the traveler's car rental reservation and inputted into the system that is implementing the details of this invention. Such reservation details could include the time that the vehicle is to be picked up and/or flight data (if the rental car pick up location is at an airport). During strategic times in a traveler's travel, such as during the hour before boarding the flight which will lead to the city where the rental car has been ordered, or immediately upon arrival of the flight at the airport where the rental car facility is located (by checking flight status databases), a notification could be sent to the traveler, such as by text message or email, further inquiring if any items are to be purchased. Such notifications would happen sufficiently far in advance of the traveler picking up the rental car, that rental car personnel would still have ample time to fill the order before the traveler arrives for picking up the rental car at the rental car facility. Such additional services being advertised to the traveler could be controlled by the traveler, such as by inviting the traveler to receive such notifications at strategic times during the traveler's trip.

If, for various reasons, items in inventory are desired to be cleared out of inventory, information such as sale information could be communicated to travelers, so the travelers would have an opportunity to get a particularly good deal for the items being provided, and have them conveniently provided to the traveler either in the rental car when it is picked up or at the check-in counter of the rental car facility or in some other convenient fashion. As a result, travelers have the benefit of shopping for any needed travel items or other items without needing to go through the traditional shopping experience. Traveler time spent waiting in line (at security or while boarding or on the plane for instance) can be used to shop for needed items and have them delivered to a rental car or to a hotel or other traveler destination, to be there ahead of the traveler or shortly after traveler arrival.

Branding of the particular service and system provided by this invention could be separate from the rental car operator or could be provided as a service to the rental car company, so the rental car company is actually providing the service and branding of the rental car company would be reinforced throughout the purchasing process, with the operator of the system of this invention merely supplying the functionality, such as maintaining the inventory systems, purchasing systems and various different communication channels, but with the traveler facing portions of any website or app matching that of the rental car provider. A third option would be to co-brand this service in a manner which includes both the name of the rental car operator and also the provider of the service of this invention.

As many airports and other locations have multiple different rental car lots located at a common location and with the car inventories near each other and the check-in counters located near each other, in one embodiment a single inventory location could be provided and service multiple different rental car companies and travelers thereof with the service of this embodiment of the invention. Either the inventory location could be accessed by authorized personnel from each rental car company, or an individual or group of individuals having authorization to access the inventory location of items would have authorization to either access the cars of the individual rental car companies, or would deliver the items which have been purchased by the traveler to rental car personnel for a “hand off,” so the rental car personnel can either deliver the items directly to the consumer at a rental car check-in counter, or place the items directly in the rental car which has been reserved (or otherwise provide the purchased items at an identified secure location for pick up by the traveler).

While hotels and rental car hubs have been disclosed in detail above as traveler destinations which can have ordered items delivered thereto, other traveler destinations could also be served by this invention, including aircraft seats, cruise ship cabins, train seats/cabins, bus seats, airport lockers and a variety of other traveler destinations.

### OBJECTS OF THE INVENTION

Accordingly, a primary object of the present invention is to provide a system for delivery of selected items to a traveler at a traveler destinations, the destination being a final destination for the traveler or an intermediate destination the traveler is passing through.

Another object of the present invention is to provide a method for delivering items selected by a traveler to a destination of the traveler, which could be a final destination or an intermediate destination, where the traveler is located or will be located in the future.

Another object of the present invention is to supply a traveler with items needed by the traveler, such as lost or stolen items, or items which the traveler neglected to pack.

Another object of the present invention is to provide an inventory availability app which can run on a mobile computing platform, such as a smart phone, with the app displaying inventory available at (or within a delivery distance from) a traveler destination.

Another object of the present invention is to provide a dynamic delivery device which fulfills ordering of an item to a delivery location which is a temporary location for a traveler who orders the item.

Another object of the present invention is to quickly supply needed items to a traveler at a traveler destination, including a traveler's final destination and/or one or more intermediate destinations of the traveler.

Another object of the present invention is to provide a system and method for allowing a traveler to conveniently order an item while traveling and have the item delivered to a convenient present or future location of the traveler.

Other further objects of the present invention will become apparent from a careful reading of the included drawing figures, the claims and detailed description of the invention.

### BRIEF DESCRIPTION OF THE DRAWINGS

FIG. 1 is a schematic depiction of portions of a system for dynamic delivery of ordered goods to a traveler destination, when the traveler destination is associated with a hotel, according to one example embodiment of this invention.

FIG. 2 is a perspective view of a mobile computing device, generally in the form of a smart phone, illustrating how an app running on the smart phone can allow inventory at a traveler destination to be accessed for purchase and to initiate delivery of ordered items to a traveler destination.

FIG. 3 is a flow chart illustrating a series of steps associated with a traveler utilizing the system and method of this invention to place an order for desired items and to have such desired items efficiently delivered to the traveler at a traveler destination.

FIG. 4 is a schematic depiction of portions of the system for dynamic delivery, such as those associated with FIGS. 1, 3, 5 and 6, and illustrating how various optional subparts of the system interact together to implement the system and method of this invention.

FIG. 5 is a schematic depiction of an embodiment of the system and method of this invention where inventory is carried on a mobile inventory van which services multiple different properties, such as hotels, for delivery of ordered items according to one example embodiment of this invention.

FIG. 6 is a schematic depiction of an embodiment of the system and method of this invention where inventory is carried at a rental car hub or other transport hub for delivery of ordered items to a traveler at a traveler destination which is an intermediate destination of the traveler as the traveler is traveling to a final destination.

### DESCRIPTION OF THE PREFERRED EMBODIMENT

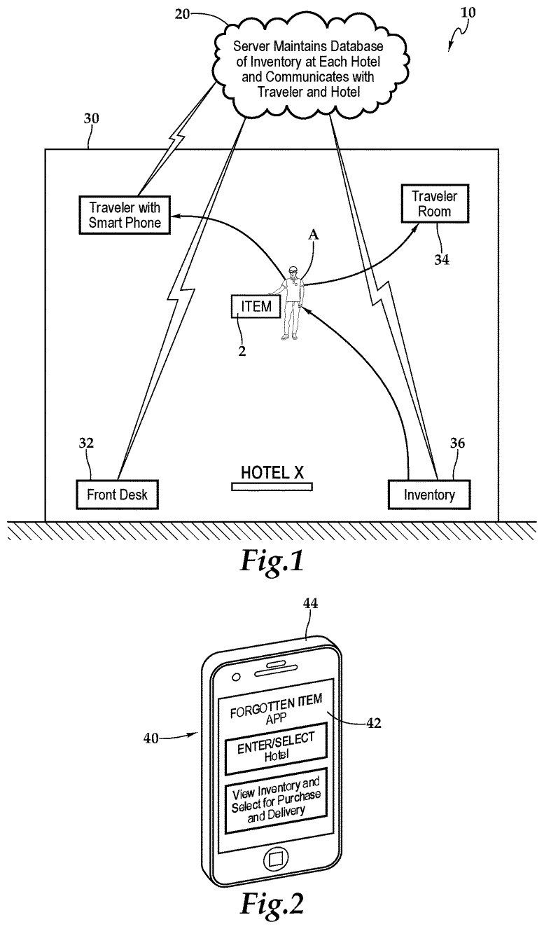

Referring to the drawings, wherein like reference numerals represent like parts throughout the various drawing figures, reference numeral 10 (FIGS. 1 and 4-6) is directed to a system for dynamic delivery of ordered items 2 out of one or more inventories 36, 66, 70, 94 at travel locations to traveler destinations (such as properties 30, 60, 90, 100) under the control of a server computer 80 with which a traveler T is interacting to place an order.

In essence, and with particular reference to FIG. 4, a server computer 80 maintains updated inventory information for inventory 36, 66, 70, 94 (FIGS. 1 and 4-6) at various different travel locations at or near traveler destinations. The server 80 can also facilitate purchase transactions or purchase transactions can be facilitated through other computers. The server 80 is a computer 88 coupled to a wide area network 20 such as the Internet. A traveler smart phone 40 or other mobile (or non-mobile) computing device accesses the server 80 through the wide area network 20. The smart phone 40 displays inventory available at a traveler destination, such as through an app running on the smart phone 40 and an order (purchase or rental) of desired items is placed by the traveler T. The server computer 80 communicates through the wide area network 20 with an agent A with access to an inventory 36, 66, 70, 94 near the traveler destination with instructions to deliver items 2 ordered by the traveler T to the travel destination. The inventory 36, 66, 70, 94 is located at or at least within a delivery distance from the travel destinations such as a traveler temporary residence property 30, rental car hub 60, transport hub 90 or other location such as a seat on an airplane 100 or other common carrier the traveler T will be traveling upon. Goods needed by the traveler T are thus made available for order by the traveler T from inventory 36, 66, 70, 94 which is at or near a traveler destination, to facilitate effectively matching of the ordered item with the traveler T in a rapid and efficient manner.

More specifically, and with particular reference to FIG. 4, basic elements associated with the system and method of this invention are described, according to an example embodiment. Elements which facilitate practicing of the method of this invention can be concentrated to a greater extent in one location or can be distributed to a greater extent at multiple locations. Basic elements of the system of this invention include a server computer 80 which maintains inventory information and optionally facilitates other steps in the practicing of the method and implementation of the system of this invention, such as completing payment transactions and sending of delivery instructions. In other embodiments, separate systems either under control of the operator of the server computer 80, are not controlled by but coordinated with the operator of the computer/server 80, can be utilized in various embodiments of this invention.

In addition to one or more such server computers 80, at least one smart phone 40 (FIGS. 2, 5 and 6) or other traveler computing device is utilized as part of the system and method of this invention. The smart phone 40 or other computing device is typically a mobile computing device (such as a tablet computer or laptop computer), but could be a stationary computing device such as a personal computer or terminal (e.g. a kiosk, airplane seat back display or other input device, generally including a display and input controllable by a traveler).

The system and method 10 of this invention also includes one or more properties 30 which can be hotels or other temporary accommodations facilities. Such properties 30 are one form of travel location where an inventory can be kept. Other travel locations where an inventory can be kept include rental car hubs 60, mobile inventory vans 70 or other vehicles which are located within delivery distance of one or more properties, and which can contain inventory within the vehicle itself or an agent A operating the vehicle 70 can have access to an inventory location at one or more properties 30 or other locations within a delivery distance of the properties 30. Furthermore, the travel location could be an airport 90 or other transport hub through which the traveler T will be traveling in the future, or where the traveler T is currently located. Another travel location could be some form of common carrier vehicle/vessel where the traveler T is currently located or the traveler T is scheduled to be located in the future.

The server computer 80, smart phone 40 or other computing device controlled by the traveler T and one or more travel locations include telecommunications equipment to facilitate communication therebetween. This telecommunications equipment can be in the form of antennas and appropriate electronics on a smart phone 40 or other mobile computing device, or can be in the form of a wired or wireless modem 82, such as in the case of the server computer 80 and various different computers or other computation devices at the various different properties 30 or at the rental car hub 60, within the delivery van 70, or at the airport 90 or upon an airplane 100 or other common carrier.

Communications according to the method and system of this invention can be according to various different protocols to facilitate reliable and efficient communication between the various different elements associated with the system of this invention. In one example embodiment, these communications protocols are Internet communications protocols and a wide area network 20 in the form of the Internet is utilized to facilitate such communications between these various different computation devices to implement the method and system of this invention. As an alternative, other wide area networks 20 could be utilized, and such networks would typically be wireless, at least partially, but could be a mix of wired and wireless networks or could conceivably be an entirely wired network in certain embodiments.

Functions performed by the server computer 80 could be divided up into multiple separate computers. For instance, memory with which the server computer 80 stores inventory information could be at the same location as the server computer 80, or could be distributed at some separate location or locations. In this respect, it can be convenient to think of the wide area network 20 utilizing the appropriate communications protocol to be like a “cloud” with the various devices interacting with the “cloud” to facilitate ordering and fulfillment of dynamic delivery transactions according to the system and method of this invention.

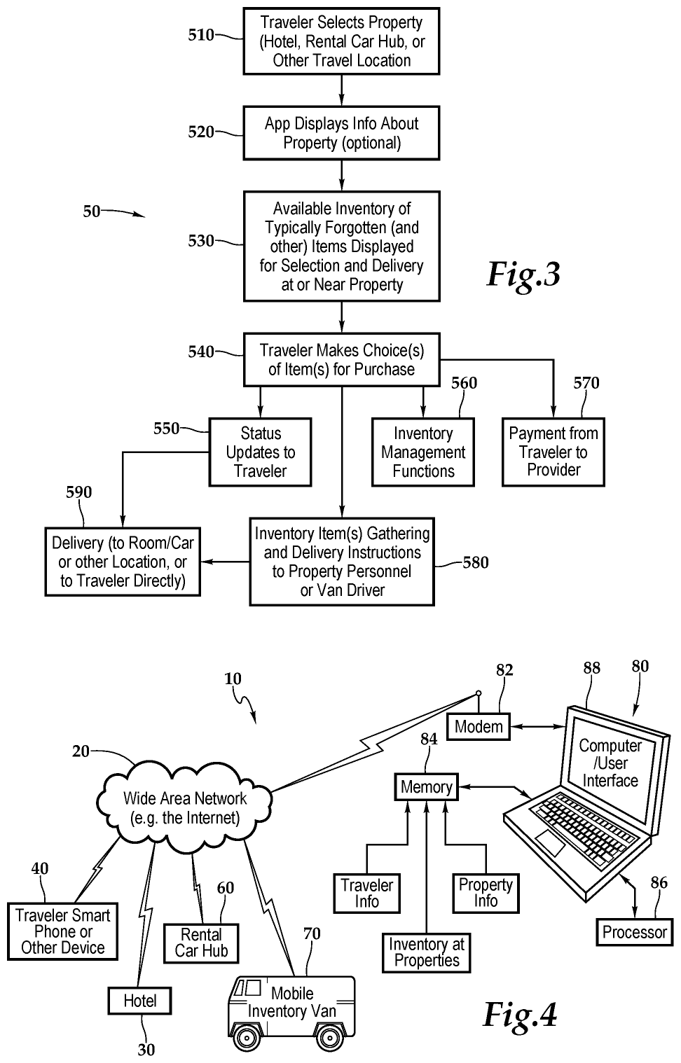

FIGS. 2 and 3 illustrate details of the smart device 40, and the app running thereon which interface with the traveler T and facilitate the placement of orders, and associated functionality of the system and method of this invention, according to an example embodiment. While the smart phone 40 is shown as one mobile computing device, it could be replaced with various other computing devices as described above. The smart phone 40 or other computing device would typically be mobile computing device including an antenna 44 for communications with other portions of the system 10 of this invention. Such antenna 44 is typically configured to facilitate radio frequency communication through a cellular network, but could utilize satellite radio frequency telecommunications, or other bandwidths of photonic radiation, or sound waves or other wireless propagation, or could utilize at least partially wired communication by plugging the smart phone 40 or other device into a wired (including fiber optics and other data transport) telecommunication networks.

Typically a customized app is running on the smart phone 40, but the system and method of this invention could operate through a website with which the server computer 80 is also connected (or which the server computer 80 is hosting). Other forms of software interaction between the smart phone 40 and server computer 80 could also conceivably be utilized. The app can be selected by the traveler T or can be automatically launched by the smart device 40 responsive to prompts from the traveler or automatic launching instructions which caused the app to be active on the smart phone 40.

In many example embodiments, a first action of the traveler T is to select a desired traveler destination at which the traveler T is either already located or which the traveler T will be traveling to as a final destination or traveling through as an intermediate destination. In various environments, the traveler T could select more than one such traveler destinations, which might increase a variety of inventory items which are available at the one or more traveler destinations. In other embodiments, the traveler T does not need to select a traveler destination because such information may already be at least partially known by the app (and the server computer 80 at least partially controlling operation of the app). For instance, a hotel to which the traveler is traveling might already have been communicated to the server computer 80. and passed along to the app running on the smart phone40, so that the traveler T does not need to select the traveler destination before utilizing the app.

Another preliminary step which can be implemented by the app running on the smart phone 40 is communication to confirm that the traveler T wishes to interact with the app. This information would typically relate to communication confirming that the traveler T is in need of some item of goods. This item might be an item which the traveler T forgot to pack when beginning a traveler's journey, or an item which was lost, stolen or broken after the traveler T began the journey. Such communication would be a notification on the smart phone 40 or an email or a simple messaging service (SMS) “text.”

After the app has had one or more traveler destinations identified, the app communicates with the server computer 80 to receive a catalog of inventory available at the inventory 36, 66, 70, 94 within a delivery distance of the traveler's destination(s). This catalog of inventory can be displayed in various ways for browsing by the user. As another option, a search panel can appear on the smart phone 40, and a user can interact with a search function associated with the app to search for items desired by the traveler T. Most preferably, subcategories of items are provided, and each item includes both text and at least one photograph, and pricing information displayed to the user, so that the user can rapidly find desired items, evaluate pricing and make final purchasing decisions.

Typically the app will have a form of checkout procedure, such as including a “shopping cart” which can be “filled” with items tentatively desired to be purchased, and a means to edit the shopping cart before final check out. The app running on the smart phone 40 can be pre-loaded with financial information, or the app can coordinate with other payment processing apps to complete the payment portion of the overall purchasing (or rental) transaction. As another option, financial transaction systems can be facilitated by the smart phone 40, such as through software running natively on the smart phone 40, such as in the case of Apple Pay running natively on an iPhone provided by Apple Inc. of Cupertino California, or equivalent systems running on other smart phone platforms.

Once purchasing decisions have been finalized and the financial transaction has been completed (or at least initiated), the system of this invention takes over to fulfill the order having the selected item(s) pulled from inventory and transported to the traveler destinations. The app running on the smart phone 40 can, in at least one embodiment, include order tracking functionality. This functionality can include details as to orders which have been placed and provide updates, such as when items are pulled from inventory and this information is uploaded to the server computer 80, the server computer communicates with a smart phone 40 through the operating on the smart phone 40 to update delivery status as being “in transit.” Finally, when the delivery has been completed to the traveler destination, status of the item having arrived at the traveler destination for pick up can be communicated back through the system 10 to the smart phone 40 for communication to the traveler T.

Furthermore, final pick up instructions can also be provided to the traveler T, as necessary, through the smart from 40, such as whether items 2 are to be picked up at a hotel front desk 32 or whether they were slid under the door at the traveler room 34 within the hotel 30, or whether other pick up instructions are involved. If problems are encountered when attempting to implement the delivery step, such problems can be communicated to the traveler T, such as in the form of a delay notification (and perhaps identification of the length of such delay) and/or lack of inventory, or other problems fatal to the delivery process. Such communication can allow the traveler T to select between options such as canceling the order and obtaining a refund, and re-initiating operation of the system 10 and associated method, perhaps with other travel destinations and/or other inventories to achieve success in acquiring desired items 2 from a different inventory location or for delivery to a different travel destination.

With a particular reference to FIG. 3, steps in the implementation of the method of ordering and delivery according to this invention are illustrated in the form of a flow chart 50. Initially, the traveler selects a property following step 510. This property can be a hotel property 30, rental car hub 60, airport 90, or other traveler destination. As noted above, this step 510 can be automated in some example embodiments of this invention, rather than involving traveler T property selection.

Step 520 involves an app running on the smart phone 40 (or other mobile computing device or other computing device) with the app displaying information about the property which is the traveler destination selected. Such information can be used to verify with the traveler T that the property involved is one the traveler T is traveling to. Also, maps can be provided, and item pick up locations can be clearly identified on such maps. Other information can also be provided about the property selected, which information might be useful to the traveler T.

Step 530 involves the app displaying inventory available for purchase, rental or other acquisition. This inventory that is displayed is the inventory which is available at the property selected in step 510. In step 540, the traveler makes choices as to what items to purchase.

A series of steps then are initiated. Step 550 is initiated which provides a series of status updates to the traveler so that the traveler T can monitor progress of the delivery. Step 560 involves inventory management functions occurring, such as with the server computer 80 decreasing by an appropriate number from inventory the number of items 2 which have been purchased or otherwise acquired by the traveler T. Such inventory management functions can also include initiating automatic re-order if inventory of a particular item is getting too low. Step 570 is also initiated which involves taking payment from the traveler T and providing payment to the provider of the system 10 of this invention.

The system 10 also, according to step 580, provides delivery instructions to an agent A, such as property 30 personnel or a van 70 driver. These instructions can include a notification on a smart phone carried by an agent A who has authorized access to the inventory 36, 66, 70, 94 at or within delivery distance from the traveler destination which is specified for delivery of particular items 2. This notification can identify which items should be pulled from inventory, or instruct the agent A to launch an app which lists the items 2 to be pulled from inventory. The agent A can then travel to the inventory 36, 66, 70, 94, pull the selected items, and transport them to the traveler destination. Such travel destination can, for instance, be a front desk 32 of a hotel 30 or similar property, or a locker 62 at a rental car hub 60, or a car 64 at a rental car hub 60, or a locker 92 at an airport or other transport hub, or a seat or cabin on a common carrier such as an airplane 100, bus, train, or vessel. Step 590 involves final delivery of items 2 order by the traveler T at the traveler destinations.

With particular reference to FIGS. 1, 5 and 6, details of different types of properties 30, 60, 90, 100 are described, illustrating various different traveler destinations where delivery can be consummated according to the method and system 10 of this invention, according to various example embodiments. In FIG. 1, the traveler destination is a property 30 such as a hotel, resort, temporary traveler T residence, campground, motel, inn, or other place of residence for the traveler T. A typical property 30 includes a front desk 32 and various different rooms, at least one of which is a traveler room 34. A secure inventory 36 location is also typically located within the hotel or other property 30. The property 30 may have other locations therein which could be identified as locations which could qualify as the traveler destination, such as a poolside table or chair, a conference room, a restaurant, golf course, tennis courts, beach area, etc. A traveler destination could also conceivably be the location of a smart phone 40 or other mobile computing device carried by or associated with the traveler T, which smart phone 40 can include a GPS or other location identification system which identifies coordinates which coordinates would be the traveler destination where a delivery according to the system 10 and method of this invention can occur.

Typically some location within the property 30 communicates with the server computer 80 through the wide area network 20 such as the Internet. This communication location could be for instance the front desk 32. The communication location could be a fixed computer. As an alternative, it could be a mobile device, such as a smart phone 40 of an agent A. This agent A might be an employee of the hotel or other property 30, or some person who has authority from the property 30 to be present upon the property 30. This agent A would also have privileges to access an inventory 36 location, which might be a secure room, closet etc. The agent A receives the list of items to be delivered and the specific traveler destinations associated with the property 30. The agent A travels to the inventory 30, pulls the items 2 to be delivered, and then travels to the final traveler destination to drop off the items 2 or to hand them directly to the traveler T if the traveler T is present.

Agent A also can communicate, such as through a smart device 40, back to the server computer 80 through the wide area network 20 what is the particular status of the delivery process. As one option, the inventory 36 can know when it is accessed, and prompt the agent A to identify items which have been grabbed. The agent A could utilize some sort of tool, such as a handheld barcode scanner, to scan items as they are pulled from inventory, which scanner could communicate with the smart phone 40 of the agent A or communicate directly through the wide area network 20 to the server computer 80. Automated updates can be fed to the traveler T such as to the smart phone 40 of the traveler T.

Finally, further status can be uploaded into the system 10 when the agent A completes the delivery, such as by the agent A utilizing a smart phone 40, selecting the delivery which has been completed, and providing final status, and any final notes associated with delivery. Such notes could include time of delivery, precise location where delivery occurred, access codes to gain access into secure lockers at the traveler destination delivery location, or other pertinent information to help facilitate the traveler T to gain access to the delivered items 2.

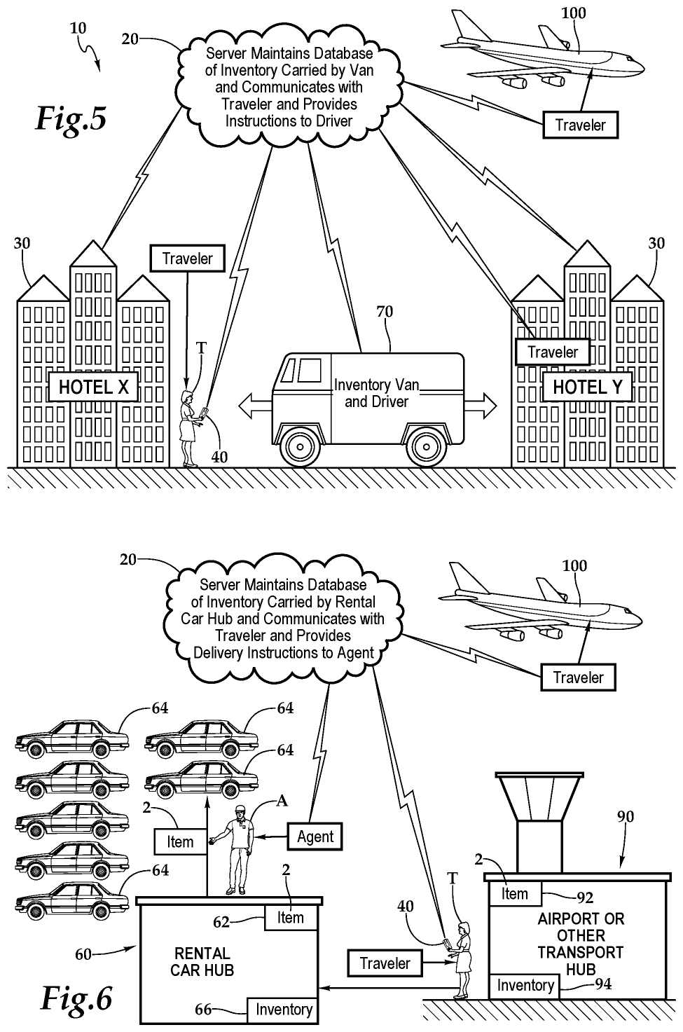

With particular reference to FIG. 5, an embodiment of this invention is disclosed which involves multiple properties 30 served by a single (or multiple) inventory van 70 and an associated driver which acts as an agent A for delivery in at least one embodiment. Such a van 70 could have inventory located within the van 70 itself. As another option, inventory could be kept at one (or more) of the properties 30, or some other location in the vicinity. The system 10 of this invention involves the server computer 80 sending instructions to the agent A (typically the driver) with the van 70. The final delivery process will be similar to that described above with respect to the properties 30 (FIG. 1), except that a new step would be involved, associated with the driver/agent A driving the van 70 to the property 30 which is designated as the traveler destination, before the agent A finally either drops off the item 2 at the front desk 32 of the property 30 or within a secure locker at the property 30, or dropping off the ordered items at the traveler room 34, or other location associated with the property 30.

With particular reference to FIG. 6, an embodiment of the system 10 of this invention is disclosed where the traveler destination is an intermediate destination, such as a rental car hub 60, an airport 90 or an airplane 100 or other common carrier mobile platform. In the case of a rental car hub 60, a computer (or smart phone of an agent A) at the rental car hub 60 would receive delivery instructions from the server computer 80 through the wide area network 20 such as the Internet. The agent A would then have a series of options for providing the ordered items to the traveler T. One option would be to gather the items 2 from the inventory 66 at the rental car hub 60 and then place them within the car 64 which has been reserved by the traveler T. Another option would be to hold the ordered items 2 at a counter at the rental car hub 60 for pick up by the traveler T. Another option would be to provide the ordered items 2 within a locker 62 at a locker area within the rental car hub 60.

As another option, the ordered items 2 could be delivered to a control gate operator at a control gate of a rental car hub 60, and ordered items 2 would be passed directly to the traveler T when the traveler T is checking out the reserved rental car 64 from the rental car hub 60. Particular details as to where the traveler T will find the ordered items can be fed back to the smart phone 40 of the traveler T, so that the traveler T knows whether to pick up ordered items at a counter, within the car, within a locker, or at the exit control gate of the rental car hub 60.

In the case of an airport or other transport hub 90, some agent A at this facility would have access to an inventory 94. A pick up counter could be provided at such a transport hub 90 which is staffed by the agent A. As an alternative, pick up lockers 92 could be loaded with the ordered items 2, and final pick up instructions sent to the traveler T can include codes to access the locker where the ordered items 2 have been placed. The agent A could be some agent with other responsibilities at the transport hub 90, so that only one of the tasks of the agent A would be fulfilling orders according to the system and method of this invention.

In the case of an airplane 100 or a cruise ship or other vessel, or other common carrier such as a bus, train or private car, some agent A with access to the vehicle/vessel would receive delivery instructions, such as to a mobile device carried by the agent A, such as a smart phone 40. An inventory location could be located upon the vehicle/vessel itself or could be at a port/station accessed by the vehicle/vessel. The agent A could access the inventory, pull the items from the inventory which were ordered, and then deliver them to the vessel/vehicle. Typically the vessel/vehicle would be one which the traveler T has booked transportation upon, ahead of the traveler T arriving at the port/station to ride on the vehicle/vessel. The agent A could place the ordered items in the seat or cabin reserved by the traveler T. Other delivery locations could be jetways, and other entrance locations for vessels or other vehicles which can be identified in pick up instructions sent to the smart phone 40 of the traveler T. Then, when the traveler T arrives at the vehicle/vessel in the designated cabin or seat thereof, the traveler T can pick up the ordered items.

While the traveler T could order items from home before commencing travel, typically the traveler T is already involved in travel away from home when it is discovered that an item needs to be ordered. The traveler T could be in a car or in some location whether cellular service is available, and the user would access the server computer 80, via the app running on the smart phone 40 and through the wide area network 20 such as the Internet, to place the order. The traveler T might be at an airport 90 when discovering that an item has been lost and need to be ordered. For instance, a traveler T might have lost an item during security screening or left an item in the traveler T car at the airport 90, and retrieval of the item 2 is not practical or possible. Items 2 can be ordered through the app running on the smart phone 40 for utilizing the system 10 of this invention for delivery at the property 30 which is a final traveler destination or some intermediate destination, such as the rental car hub 60 or a destination airport 90, or some other depot, or the vehicle/vessel itself which the traveler T will be riding upon. The traveler T might already be on an airplane 100 or other vehicle/vessel which vehicle/vessel has Internet access or otherwise access to a wide area network 20 to which the server computer 80 is also connected. Such access might be through the traveler T smart phone 40 or other mobile computing device, or might be through some interface such as a seat back touchscreen display on an airplane 100. Items 2 can be ordered through the app from inventories 36, 66, 70, 94 which are available at either a final or intermediate destination for the traveler T

This disclosure is provided to reveal a preferred embodiment of the invention and a best mode for practicing the invention. Having thus described the invention in this way, it should be apparent that various different modifications can be made to the preferred embodiment without departing from the scope and spirit of this disclosure. When embodiments are referred to as “exemplary” or “preferred” this term is meant to indicate one example of the invention, and does not exclude other possible embodiments. When structures are identified as a means to perform a function, the identification is intended to include all structures which can perform the function specified.

What is claimed is:

1: A method for dynamic delivery of ordered goods to a traveler's location, the method including the steps of:
staging inventory at a plurality of travel locations;
communicating inventory contents at the plurality of travel locations to a server computer;
accessing the inventory contents information from the server computer by a traveler having one or more traveler destinations, at least one of which traveler destinations being within a delivery distance from the travel location associated with the inventory contents being accessed;
ordering at least one available item in the inventory located at the travel location, by the traveler; and
delivering at least one ordered item from said ordering step from the inventory at the travel location to the traveler destination.

2: The method of claim 1 wherein said ordering step includes purchasing at least one item from the inventory at the travel location.

3: The method of claim 1 wherein said ordering step includes renting at least one item from the inventory at the travel location.

4: The method of claim 1 wherein said delivering step includes sharing traveler order information with an agent having access to the inventory at the travel location, the agent gathering at least one ordered item from the inventory, and the agent traveling to the traveler destination and dropping off the at least one ordered item for the traveler to collect the at least one ordered item.

5: The method of claim 1 wherein the plurality of travel locations include locations taken from the group of locations including hotels, temporary residences, rental car providers, rental car hubs, airports, transport hubs, airplanes, trains, cruise ships, mobile inventory locations near travel locations and non-mobile inventory locations near travel locations.

6: The method of claim 1 wherein said staging step includes the inventory kept in a secure environment with access limited to at least one authorized agent.

7: The method of claim 1 wherein said accessing step and said ordering step occur at least partially through a mobile computing device carried by a traveler, and having a screen for display of inventory contents and inputs for the traveler to make selections of inventory.

8: The method of claim 7 wherein the mobile computing device is a smart phone having a touchscreen display and a wireless connection to the server computer through a wide area network.

9: The method of claim 1 wherein the traveler destination is taken from the group of destinations including a hotel room, a front desk of a hotel, a location of a smart phone of the traveler, a rental car, a rental car hub, a locker at a transport hub, and a seat or cabin on a common carrier transport vehicle or vessel.

10: The method of claim 1 wherein said delivering step occurs from an inventory at a travel location which is a delivery distance away from the traveler destination, said delivery step including an agent traveling with the at least one ordered item from the inventory at the travel location to the traveler destination.

11: A system for ordering and delivery of items, including forgotten travel items to a traveler destination, comprising in combination:
a remote server maintaining a database of inventory located at or near multiple different locations;
an app running on mobile computing devices of travelers and communicating with the server wirelessly, the app configured to allow a traveler to input a particular traveler destination where the traveler is traveling to or through;
the app configured to list available inventory associated with the traveler destination, after the traveler destination is added; and
the server configured to send inventory delivery instructions from an inventory location at or near the traveler destination to the traveler destination when the traveler selects an item from inventory on the traveler's mobile computing device for delivery to the traveler.

12: The system of claim 11 wherein said traveler destination is associated with a temporary residence for the traveler.

13: The system of claim 12 wherein said traveler destination is a room of a hotel.

14: The system of claim 12 wherein said traveler destination is a front desk of a hotel.

15: The system of claim 11 wherein said traveler destination is associated with a rental car facility being utilized by the traveler.

16: The system of claim 15 wherein said traveler destination is an interior of a car at a rental car facility which has been rented by the traveler, but not yet picked up by the traveler.

17: The system of claim 15 wherein said traveler destination is a control point at a rental car facility at which the traveler has rented a car.

18: The system of claim 15 wherein said travel destination is a counter at a rental car facility which the traveler can visit to pick up ordered items while the traveler is picking up the rental car.

19: The system of claim 11 wherein said travel destination is a particular location on a common carrier vehicle or vessel which has been reserved by the traveler for transportation of the traveler.

20: The system of claim 19 wherein said travel destination is an assigned seat on an aircraft which has been assigned to the traveler.
